(19) United States
(12) Patent Application Publication
(10) Pub. No.: US 2019/0259555 A1
(43) Pub. Date: Aug. 22, 2019

(54) CONTACT-POINT TIMER SWITCH

(71) Applicant: NIDEC SANKYO CORPORATION, Nagano (JP)

(72) Inventor: Junya KARASAWA, Nagano (JP)

(73) Assignee: NIDEC SANKYO CORPORATION, Nagano (JP)

(21) Appl. No.: 16/331,985

(22) PCT Filed: Sep. 6, 2017
(86) PCT No.: PCT/JP2017/032067

§ 371 Date: Mar. 11, 2019

(30) Foreign Application Priority Data
Sep. 14, 2016 (JP) 2016-179093

(51) Int. Cl. H01H 43/10; F25D 21/06; G04F 3/06; H01H 43/02

(52) U.S. Cl. CPC H01H 43/101; F25D 21/06; H01H 43/022; H01H 43/026; G04F 3/06

(57) ABSTRACT

A contact-point timer switch having an explosion-proof structure is provided. A defrosting timer for a refrigerator includes: contact points; a contact-point move mechanism that moves at least one contact point of the contact points, and makes the contact point contact another contact point in order to electrically connect the contact points; and a first case and a second case, while being in a stacked state, inside which stores the contact points and the contact-point move mechanism. In a first-case-side facing part of the first case, which faces the second case, and a second-case-side facing part of the second case, which faces the first case, there are provided raised bottom parts, which are raised toward an opposite-side facing part, in an area being free from overlap with the contact points and the contact-point move mechanism in a view from a stacking direction of the first case and the second case.

### TECHNICAL FIELD

The present invention relates to a contact-point timer switch for electrically connecting a point and another point by way of contact.

### BACKGROUND ART

Such a contact-point timer switch is described in Patent Document 1. The contact-point timer switch of Patent Document 1 includes a plurality of contact points, a contact-point move mechanism that moves at least one contact point of the plurality of contact points, and makes the contact point contact another contact-point in order to electrically connect the contact points, and a motor that works as a drive source for the contact-point move mechanism. The contact points are provided at a part of an electrically-conductive member being plate-like, and meanwhile the contact-point move mechanism includes a rotary cam having a cam surface where the electrically-conductive member slides on. A drive power of the motor is transmitted to the rotary cam.

### CITATION LIST

### Patent Literature

Patent Document 1: Japanese Unexamined Utility Model Application Publication No. S58-109135

### SUMMARY

### Technical Problems

In a contact-point timer switch, a contact point and another contact point contact each other so as to be electrically connected. Therefore, at a time of the contact points contact each other, there exists a possibility of causing a spark. In this situation, if the contact-point timer switch is installed in an explosive environment, such as a refrigerant gas, so as to be used for a drive control of a compressor, a heater, and the like; there is a risk that the caused spark sets off an explosion.

With the issue described above being taken into consideration, it is an issue of the present invention to provide a contact-point timer switch, with which a risk of setting off an explosion can be reduced even in the case where a spark is caused owing to contact-points contacting one another.

### Solutions to Problems

In order to solve the issue described above, a contact-point timer switch according to the present invention comprises: a plurality of contact points; a contact-point move mechanism that moves at least one contact point of the plurality of contact points, and makes the contact point contact another contact point in order to electrically connect the contact points; and a case, inside which the plurality of contact points and the contact-point move mechanism are stored. The case includes a first case and a second case, for partitioning a storage space for internally storing the plurality of contact points and the contact-point move mechanism, while the first case and the second case being in a stacked state; at least one of a first facing part and a second facing part includes a raised bottom part that is raised from a bottom toward the other facing part, the first facing part facing the second case inside the storage space in the first case, the second facing part facing the first case inside the storage space in the second case; and the raised bottom part does not interfere with the contact points and the contact-point move mechanism.

According to the present invention, inside the storage space for storing the plurality of contact points and the contact-point move mechanism in the case, there is provided the raised bottom part that is set up at least in one case of the first case and the second case, and raised toward a side of the other case. Therefore, the storage space has its capacity that is smaller than a corresponding capacity in the case where no raised bottom part is provided, in comparison. Then, if the capacity of the storage space, for storing the plurality of contact points and the contact-point move mechanism, becomes small, a risk of setting off an explosion is reduced even in the case where a spark is caused owing to the contact points contacting one another.

According to the present invention, it is preferable that the raised bottom part is provided in an area being free from overlap with the contact points and the contact-point move mechanism, in a view from a stacking direction of the first case and the second case. According to this configuration, it is easy to provide the raised bottom part so as to have no interfere with the contact points and the contact-point move mechanism.

According to the present invention, it is preferable that the contact-point timer switch includes: a motor that works as a drive source for the contact-point move mechanism; a transmission gear mechanism for transmitting a drive power from the motor to the contact-point move mechanism; and a cover, stacked on the first case from an opposite side to the second case in the stacking direction. The motor and the transmission gear mechanism are located between the first case and the cover. According to this configuration, the motor as a drive source and the transmission gear mechanism are stored in a space that is different from the storage space for the plurality of contact points and the contact-point move mechanism. Therefore, it is easy to make the capacity of the storage space small.

According to the present invention, it is preferable that the contact-point timer switch includes: a plurality of electrically-conductive members, and a number of the electrically-conductive members corresponding to a number of the contact points; each of the contact points is a part of each of the electrically-conductive members; the contact-point move mechanism includes: a rotary cam, having a cam surface on which each of the electrically-conductive members slides; and a gear mechanism for transmitting a drive power of the motor to the rotary cam; and each of gears for making up the gear mechanism and the rotary cam have their rotation centerlines oriented in the stacking direction. According to this configuration, it is easy to move one contact point so as to make the contact point contact another contact point, by use of the drive power of the motor. Furthermore, if each of gears for making up the gear mechanism and the rotary cam have their rotation centerlines oriented in the stacking direction, it is easy to make the storage space, for the plurality of contact-points and the contact-point move mechanism, compact in the stacking direction, in comparison to a case where these rotation centerlines are perpendicular to the stacking direction. Accordingly, the capacity of the storage space can easily be made smaller.

In the present case, the gear mechanism may include a first gear to which the drive power is transmitted from the transmission gear mechanism, and a second gear that engages with the first gear. The first facing part may include: a first-case-side base surface, facing the second facing part, while sandwiching the second gear and the rotary cam between the first-case-side base surface and the second facing part; a concave part that is provided in the first-case-side base surface and recessed to become distant from the second case in the stacking direction; an opening part, provided in the concave part; and a first-case-side raised bottom part, as the raised bottom part, which is raised from the first-case-side base surface toward the second facing part. A part of the first gear may be stored in the concave part; and the first gear may engage with the transmission gear mechanism by way of the opening part. According to this configuration, the first facing part has a formation including a plurality of platform parts so that the capacity of the storage space can easily be made smaller. Furthermore, the first gear engages with the transmission gear mechanism by way of the opening part provided in the concave part so that it is easy to engage the transmission gear mechanism, located between the first case and the cover, with the first gear located between the first case and the second case.

In the present case, the first facing part may be provided with a supporting shaft holding part that holds a supporting shaft to support the second gear in such a way as to be rotatable, at a boundary between the first-case-side base surface and the concave part.

Moreover, in the present case, it is preferable that the second facing part includes: a second-case-side base surface, facing the first facing part, while sandwiching the contact-point move mechanism between the second-case-side base surface and the first facing part; and a second-case-side raised bottom part, as the raised bottom part, which is raised from the second-case-side base surface toward the first facing part, at a position being free from overlap with the first-case-side raised bottom part provided at the first facing part, in a view from the stacking direction. Moreover, it is preferable that the first case has a frame shape, and including a first-case-side outer circumferential part that protrudes from a circumferential edge of the first facing part in the stacking direction; and an edge of the first-case-side raised bottom part is continuous with the first-case-side outer circumferential part. In addition, it is preferable that the second case is has a frame shape, and including a second-case-side outer circumferential part that protrudes from a circumferential edge of the second facing part in the stacking direction; and the second-case-side raised bottom part protrudes in the stacking direction in comparison to the second-case-side outer circumferential part. Then, if both the first case and the second case are provided with the raised bottom parts, the capacity of the storage space can easily be made smaller.

According to the present invention, it is preferable that a clearance is set up between the raised bottom part provided at one facing part of the first facing part and the second facing part, and the other facing part that faces the raised bottom part in the stacking direction. This configuration makes it possible to avoid a case where a raised bottom part provided in one facing part interferes with the other facing part at a time of stacking the first case and the second case, in such a way that the first case and the second case cannot be stacked.

According to the present invention, it is preferable that the first case and the second case are made of a resin material, and one case of the first case and the second case, including the raised bottom part, is provided with a concave part recessed in the stacking direction, at an opposite side to the other case, the opposite side being of the facing part of the one case, at a position that overlaps with the raised bottom part in a view from the stacking direction. According to this configuration, it is possible to protect a thickness of the case in the raised bottom part from becoming thick. Therefore, deformation of the case owing to a shrinkage can be suppressed, for example, at a time of mold injection of the case.

### Effect of the Invention

According to the present invention, the case includes the raised bottom part in the storage space for storing the plurality of contact points and the contact-point move mechanism, so that the capacity of the storage space becomes small. Therefore, a risk of setting off an explosion is reduced even in the case where a spark is caused owing to the contact-points contacting one another.

### BRIEF DESCRIPTION OF THE DRAWINGS

FIG. 1 is an external perspective view of a defrosting timer for a refrigerator, to which the present invention is applied.

FIG. 2 is a perspective view of the defrosting timer for a refrigerator, wherein a second case is removed.

FIG. 3 is a perspective view of contact points, a contact-point move mechanism, a motor, and a transmission gear mechanism.

FIG. 4 is a plan view of the defrosting timer for a refrigerator, wherein the second case is removed.

FIG. 5 includes perspective view drawings of a first case, viewed from one side.

FIG. 6 is a perspective view drawing of the first case, viewed from the other side.

FIG. 7 includes explanatory drawings of the second case.

FIG. 8 is a sectional view drawing of the defrosting timer for a refrigerator, shown in FIG. 1, wherein being taken along a line A-A mentioned in FIG. 1.

FIG. 9 is a sectional view drawing of the defrosting timer for a refrigerator, shown in FIG. 1, wherein being taken along a line B-B mentioned in FIG. 1.

FIG. 10 includes explanatory drawings of operation of the defrosting timer for a refrigerator.

### DESCRIPTION OF EMBODIMENTS

With reference to the drawings, a defrosting timer for a refrigerator is explained below, wherein the defrosting timer for a refrigerator is described as a preferred embodiment of a contact-point timer switch to which the present invention is applied.

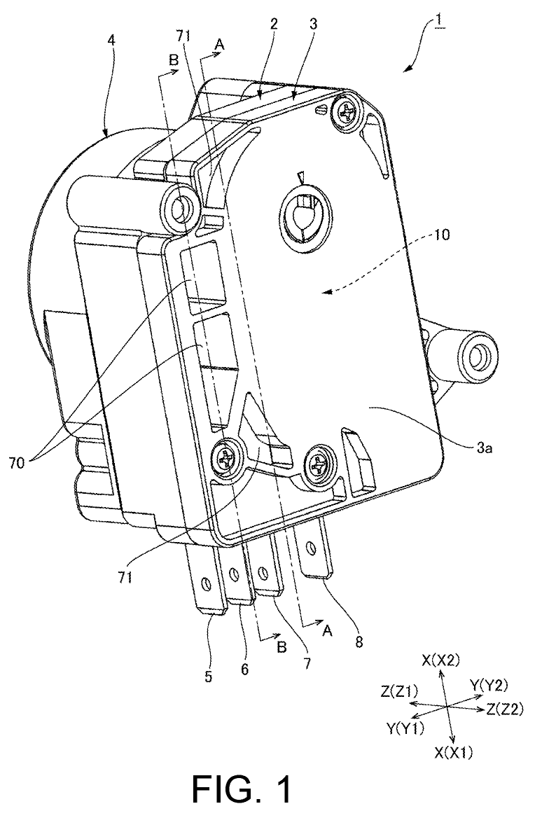

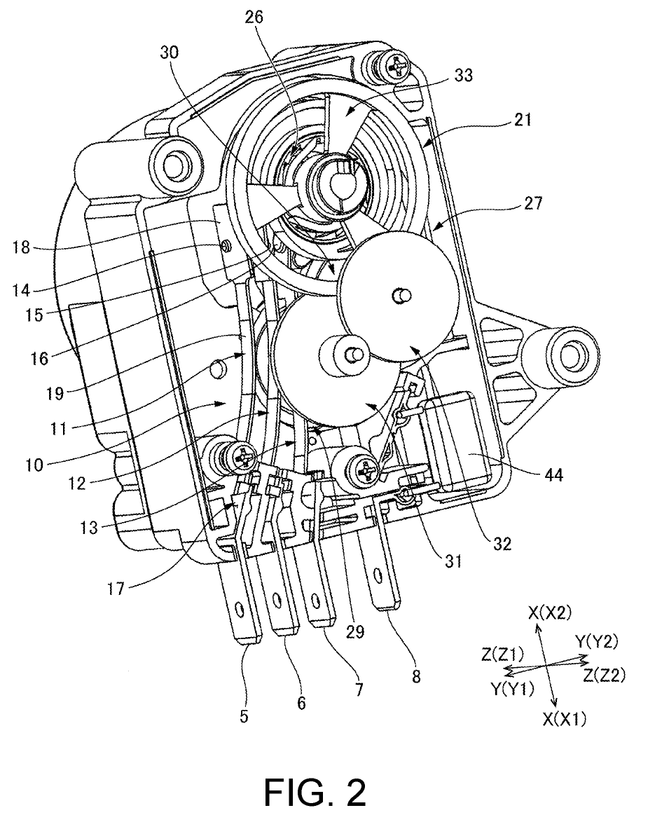

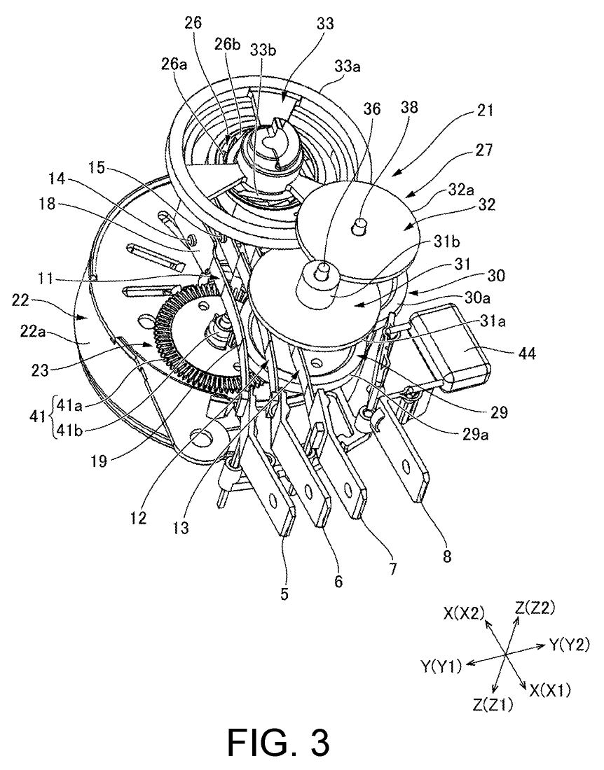

FIG. 1 is an external perspective view of a defrosting timer for a refrigerator, to which the present invention is applied. FIG. 2 is a perspective view of the defrosting timer for a refrigerator, in a state where a second case is removed. FIG. 3 is a perspective view in which contact points, a contact-point move mechanism, a motor, and a transmission gear mechanism are taken out of the defrosting timer for a refrigerator to represent those components. A defrosting timer for a refrigerator 1 (a contact-point timer switch) of the present example is installed inside a refrigerator in order to selectively operate a compressor and a heater for a predetermined period, in a time period set up in advance. The defrosting timer for a refrigerator 1, installed in a refrigerator, is exposed to a refrigerant (explosive atmosphere). Incidentally, in an explanation below, three directions perpendicular to one another are individually represented as an X-direction, a Y-direction and a Z-direction.

As shown in FIG. 1, the defrosting timer for a refrigerator 1 includes a first case 2 and a second case 3 that are stacked in the Z-direction, and a cover 4 stacked on the first case 2 from an opposite side to the second case 3 in the Z-direction (i.e., a stacking direction of the first case 2 and the second case 3). The first case 2, the second case 3, and the cover 4 are components molded out of a resin material. Moreover, the defrosting timer for a refrigerator 1 further includes a first segment 5, a second segment 6, a third segment 7, and a fourth segment 8, which protrude from the first case 2 toward one side in the X-direction. Namely, the four segments, i.e., the segments 5, 6, 7, and 8 are laid out in the Y-direction. Incidentally, as a matter of convenience in the following explanation, a side of a position of the cover 4, in relation to the first case 2 in the Z-direction, is represented as a first direction Z1 of the Z-direction; and a side of a position of the second case 3, in relation to the first case 2 in the Z-direction, is represented as a second direction Z2 of the Z-direction. Moreover, a one side in the X-direction, where the segments 5, 6, 7 and 8 individually protrude, is represented as a first direction X1 of the X-direction; and a direction opposite to the first direction X1 is represented as a second direction X2 of the X-direction. Furthermore, one side in the Y-direction is represented as a first direction Y1 of the Y-direction; and a direction opposite to the first direction Y1 is represented as a second direction Y2 of the Y-direction. Meanwhile, the first direction Y1 of the Y-direction is a side where the four segments, i.e., the segments 5, 6, 7, and 8 are eccentrically located.

In a storage space 10 provided between the first case 2 and the second case 3, which have been stacked; there are stored a first electrically-conductive member 11, a second electrically-conductive member 12, and a third electrically-conductive member 13, as shown in FIG. 2. Each of the electrically-conductive members 11, 12, and 13 is plate-like, and stretches in the X-direction while its thickness direction is oriented in the Y-direction. The three electrically-conductive members, i.e., the electrically-conductive members 11, 12, and 13 are arranged in the Y-direction while having a predetermined space between neighboring two of the members. Each of the electrically-conductive members 11, 12, and 13 is provided with a contact point (i.e., a first contact point 14, a second contact point 15, and a third contact point 16) at its tip part. A root end part of each of the electrically-conductive members 11, 12, and 13 is fixed to an electrically-conductive member fixing part 17 that is placed at an end part of the first case 2 in the first direction X1 of the X-direction. More specifically to describe, each of the electrically-conductive members 11, 12, and 13 is provided with a contact-point shaping part 18, in an area of a constant length from a top end toward a root end side. Each of the contact points 14, 15, and 16 is placed in a middle part of the contact-point shaping part 18, in such a way as to protrude at both sides in the Y-direction. In each of the electrically-conductive members 11, 12, and 13, a part extending from the contact-point shaping part 18 toward a root-end side is an elastic deforming part 19 bending in a bowed state.

In the storage space 10 between the first case 2 and the second case 3, there is stored a contact-point move mechanism 21 that moves each of the contact points 14, 15, and 16 (each of the electrically-conductive members 11, 12, and 13) for making the contact point contact another of the contact points 14, 15, and 16 in order to electrically connect the points. In the meantime, between the first case 2 and the cover 4, there are stored a motor 22 that works as a drive source for the contact-point move mechanism 21, and a transmission gear mechanism 23 that transmits a drive power of the motor 22 to the contact-point move mechanism 21, as it is understood with reference to FIG. 2 and FIG. 3.

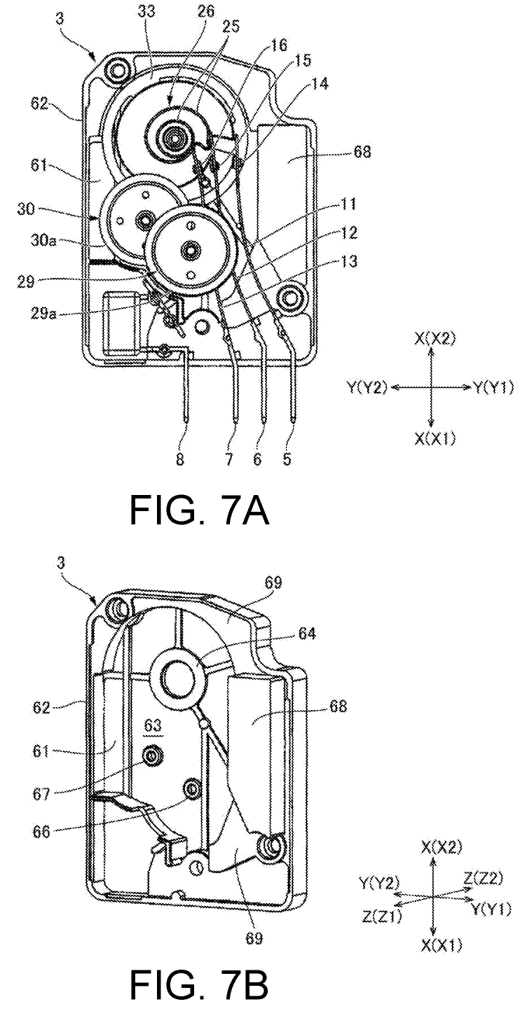

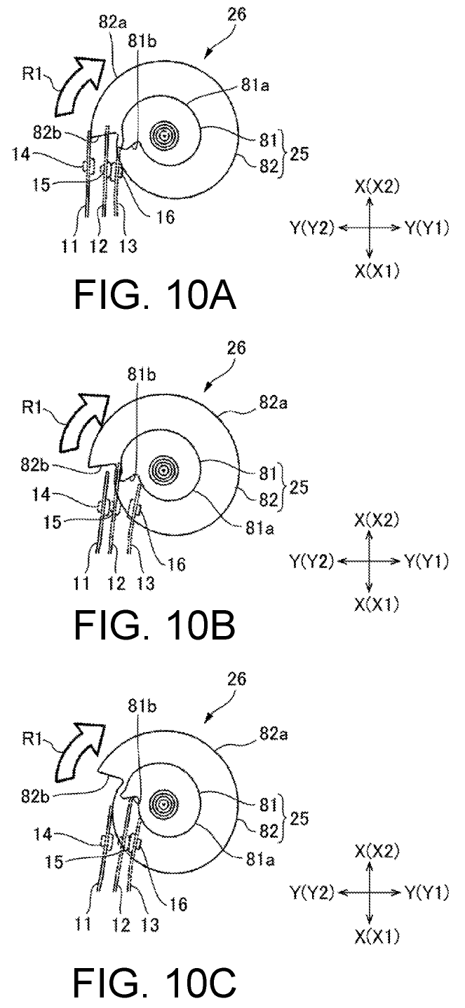

As shown in FIG. 3, the contact-point move mechanism 21 includes a rotary cam 26 having a cam surface 25 (refer to FIG. 7 and FIG. 10) on which each of the electrically-conductive members 11, 12, and 13 slides; and a gear mechanism 27 for transmitting a drive power of the motor 22 to the rotary cam 26. The gear mechanism 27 is a gear reducer mechanism that includes a first gear 29, a second gear 30, a third gear 31, a fourth gear 32 and a ratchet gear 33. The first gear 29 is a complex gear including a first large gear part 29a that engages with a transmission gear of the transmission gear mechanism 23, and a first small gear part (not illustrated) that is coaxial with the first large gear part 29a and has a smaller diameter than the first large gear part 29a. The second gear 30 is a complex gear including a second large gear part 30a that engages with the first small gear part of the first gear 29, and a second small gear part (not illustrated) that is coaxial with the second large gear part 30a and has a smaller diameter than the second large gear part 30a. The third gear 31 is a complex gear including a third large gear part 31a that engages with the second small gear part of the second gear 30, and a third small gear part 31b that is coaxial with the third large gear part 31a and has a smaller diameter than the third large gear part 31a. The fourth gear 32 is a complex gear including a fourth large gear part 32a that engages with the third small gear part 31b of the third gear 31, and a fourth small gear part (not illustrated) that is coaxial with the fourth large gear part 32a and has a smaller diameter than the fourth large gear part 32a.

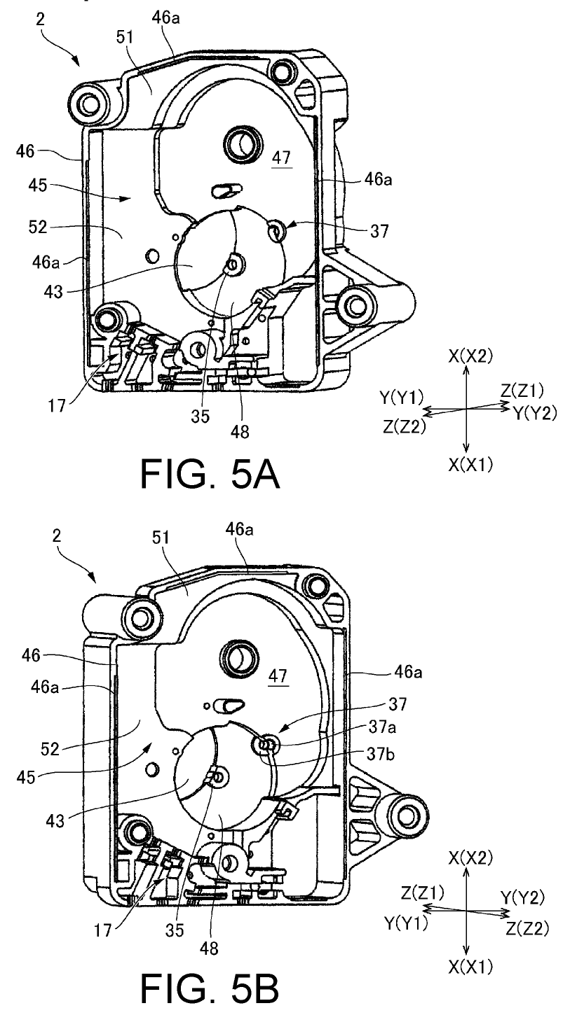

The first gear 29 and the third gear 31 are supported by a first supporting shaft 36 so as to be rotatable, wherein the first supporting shaft 36 being held by a first supporting shaft holding part 35 (refer to FIG. 5) of the first case 2. Therefore, the first gear 29 and the third gear 31 are placed coaxially, while their rotation centerlines are oriented in the Z-direction. The first gear 29 and the third gear 31 are supported by the first supporting shaft 36, while the first large gear part 29a and the third large gear part 31a are located at each side in the first direction Z1 of the Z-direction in relation to their corresponding small gear parts. The first gear 29 and the third gear 31 rotate independently from each other. In the meantime, the second gear 30 and the fourth gear 32 are supported by a second supporting shaft 38 so as to be rotatable, wherein the second supporting shaft 38 being held by a second supporting shaft holding part 37 (refer to FIG. 5) of the first case 2. Therefore, the second gear 30 and the fourth gear 32 are placed coaxially, while their rotation centerlines are oriented in the Z-direction. The second gear 30 is supported by the second supporting shaft 38, while the second large gear part 30a is located at a side in the first direction Z1 of the Z-direction in relation to the second small gear part. The fourth gear 32 is supported by the second supporting shaft 38, while the fourth large gear part 32a is located at a side in the second direction Z2 of the Z-direction in relation to the fourth small gear part. The second gear 30 and the fourth gear 32 rotate independently from each other.

The ratchet gear 33 includes a tooth part 33a, being annular, which engages with the fourth small gear part of the fourth gear 32; and a plurality of ratchet claws 33b that is provided at an inner circumferential location of the tooth part 33a, the location being further in the first direction Z1 of the Z-direction than the tooth part 33a, and the ratchet claws 33b being provided so as to be coaxial with the tooth part 33a.

Incidentally, the rotary cam 26 is placed in such a way as that its rotation centerline is oriented in the Z-direction. The rotary cam 26 is provided with the cam surface 25 around the rotation centerline. Moreover, the rotary cam 26 is provided with an annular concave part 26a at an inner circumferential side of the cam surface 25; and meanwhile an inner circumferential surface of the annular concave part 26a is provided with an engagement claw 26b that is able to engage with the ratchet claws 33b. In the ratchet gear 33, the tooth part 33a is placed at a position in the second direction Z2 of the Z-direction in relation to the rotary cam 26, and the ratchet gear 33 is placed so as to be coaxial with the rotary cam 26 in a state where the ratchet claws 33b is inserted in the annular concave part 26a of the rotary cam 26. The ratchet claws 33b of the ratchet gear 33 and the engagement claw 26b of the rotary cam 26 make up a ratchet mechanism that allows the rotary cam 26 to rotate in one direction, and controls a rotation in the other direction.

The transmission gear mechanism 23 is provided with a pinion (not illustrated) that rotates together with a rotor of the motor 22, and a transmission gear 41 that engages with the pinion. Being a complex gear, the transmission gear 41 is provided with a large gear part 41a that engages with the pinion, and a small gear part 41b that is coaxial with the large gear part 41a and has a smaller diameter than the large gear part 41a. The small gear part 41b engages with the first large gear part 29a of the first gear 29, by way of an opening part 43 (refer to FIG. 5) provided in the first case 2.

Incidentally, three segments, i.e., the segments 5, 6, and 7 positioned at a side in the first direction Y1 of the Y-direction, out of the four segments 5, 6, 7, and 8 protruding from the first case 2, are connected to the first electrically-conductive member 11, the second electrically-conductive member 12, and the third electrically-conductive member 13, respectively, in the electrically-conductive member fixing part 17. The first segment 5, to which the first electrically-conductive member 11 is connected, is connected to a heater for defrosting operation; and meanwhile the third segment 7, to which the third electrically-conductive member 13 is connected, is connected to a compressor for cooling an internal chamber. The second segment 6, located between the first segment 5 and the second segment 6 in the Y-direction, is a shared segment and connected to the second electrically-conductive member 12 and the motor 22. The fourth segment 8 located at an end in the second direction Y2 of the Y-direction is connected to the motor 22 by the intermediary of a condenser 44.

The first electrically-conductive member 11, the second electrically-conductive member 12, and the third electrically-conductive member 13 are metallic plate-like members, which are kept in a state where each tip part is biased toward a side of the rotary cam 26 by making use of elasticity with which the members are provided. Therefore, the elastic deforming part 19 of each of the electrically-conductive members 11, 12, and 13 is bowed.

At a time when the motor 22 is driven in such a way that a drive power of the motor 22 is transmitted to the rotary cam 26 of the contact-point move mechanism 21, by the intermediary of the transmission gear mechanism 23, the rotary cam 26 rotates at a certain speed in a certain direction. In the meantime, the first electrically-conductive member 11, the second electrically-conductive member 12, and the third electrically-conductive member 13 slide on the cam surface 25 of the rotary cam 26 in such a way as to make a movement between; a state where the first contact point 14 of the first electrically-conductive member 11 and the second contact point 15 of the second electrically-conductive member 12 contact with each other so as to be electrically connected, and on the other hand, the second contact point 15 of the second electrically-conductive member 12 and the third contact point 16 of the third electrically-conductive member 13 are distant from each other; and a state where the second contact point 15 of the second electrically-conductive member 12 and the third contact point 16 of the third electrically-conductive member 13 contact with each other so as to be electrically connected, and on the other hand, the first contact point 14 of the first electrically-conductive member 11 and the second contact point 15 of the second electrically-conductive member 12 are distant from each other. According to this configuration, the defrosting timer for a refrigerator 1 selectively operates the heater connected to the first segment 5 and the compressor connected to the third segment 7 for each specified period, while the rotary cam 26 makes one revolution. Incidentally, there is an explanation described later with regard to the cam surface 25 of the rotary cam 26, and the movement of the first electrically-conductive member 11, the second electrically-conductive member 12, and the third electrically-conductive member 13 which slide on the cam surface 25.

(The First Case)

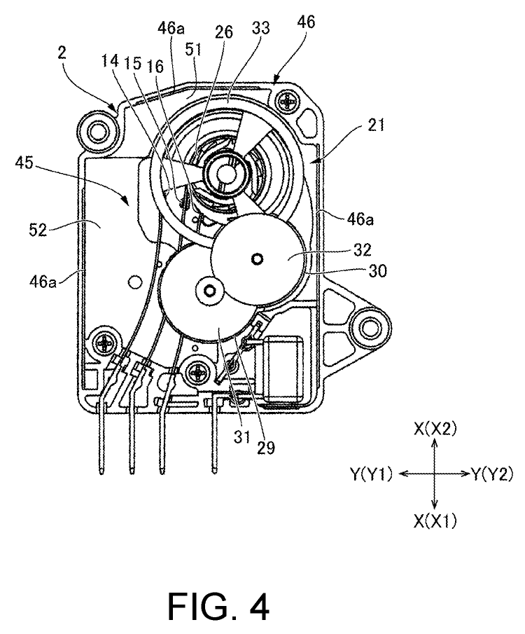

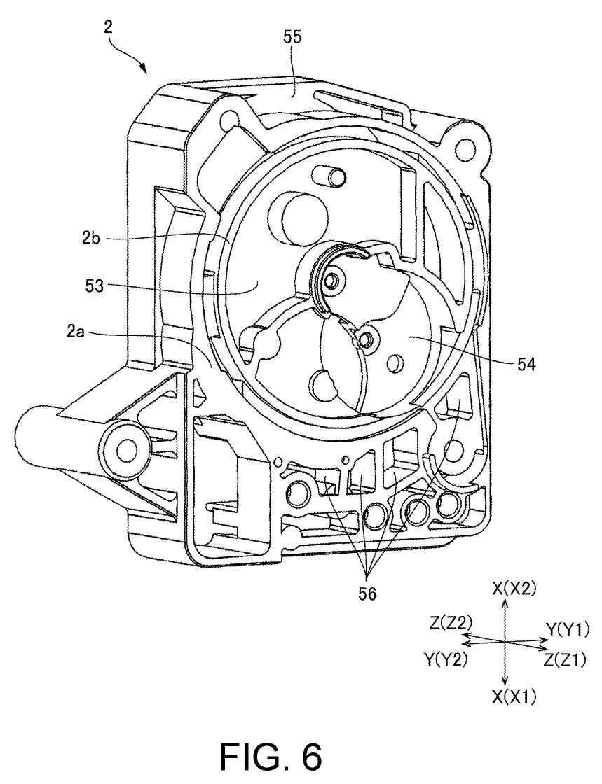

The first case 2 is explained next in details with reference to FIG. 4 through FIG. 6. FIG. 4 is a plan view of the first case 2 in which the electrically-conductive members 11, 12, and 13 and the contact-point move mechanism 21 are stored, wherein the first case 2 is viewed from a location in the second direction Z2 of the Z-direction. FIG. 5(a) is a perspective view drawing of the first case 2, viewed from a location in the second direction Z2 of the Z-direction and the second direction Y2 of the Y-direction, and meanwhile FIG. 5(b) is a perspective view drawing of the first case 2, viewed from a location in the second direction Z2 of the Z-direction and the first direction Y1 of the Y-direction. FIG. 6 is a perspective view drawing of the first case 2, viewed from a location in the first direction Z1 of the Z-direction and the second direction Y2 of the Y-direction.

As shown in FIG. 4 and FIG. 5, the first case 2 is provided with a first-case-side facing part 45 (a first facing part) that faces the second case 3, and a first-case-side outer circumferential wall part 46 that protrudes from a circumferential edge of the first-case-side facing part 45 in the second direction Z2 of the Z-direction. Being viewed from the Z-direction, the first-case-side facing part 45 has a plan view that is a rectangular form, as a whole. Accordingly, the first-case-side outer circumferential wall part 46 is like a frame being shaped to be rectangular, as a whole. At an edge part of the first-case-side outer circumferential wall part 46 in the second direction Z2 of the Z-direction, there is provided a mating part 46a that fits into the second case 3 at a time when the first case 2 and the second case 3 are stacked.

The first-case-side facing part 45 includes a first-case-side base surface 47 that faces the second case 3, while sandwiching the second gear 30, the fourth gear 32, and the ratchet gear 33, out of a series of wheels for making up the contact-point move mechanism 21, the rotary cam 26, and each of the contact points 14, 15, and 16 between the first-case-side base surface 47 and the second case 3.

Meanwhile, the first-case-side facing part 45 further includes a concave part 48, being provided in the first-case-side base surface 47 and almost circularly-shaped, and the opening part 43 provided in the concave part 48. At a central part in a bottom surface of the concave part 48, there is provided the first supporting shaft holding part 35 that holds an end of the first supporting shaft 36 in the first direction Z1 of the Z-direction. The first supporting shaft holding part 35 is shaped to be cylindrical, and the first supporting shaft 36 is press-fit into a center bore of the first supporting shaft holding part 35. In the concave part 48, there is inserted the first large gear part 29a of the first gear 29 supported by the first supporting shaft 36. The first large gear part 29a of the first gear 29 engages with the small gear part 41b of the transmission gear 41, by way of the opening part 43.

In the meantime, the first-case-side facing part 45 is provided with the second supporting shaft holding part 37 to hold an end side part of the second supporting shaft 38 in the first direction Z1 of the Z-direction, at a boundary between the first-case-side base surface 47 and the concave part 48. The second supporting shaft holding part 37 includes: a groove 37a, which is semicircular and stretches on a wall surface of the concave part 48 in the Z-direction; and a protruding part 37b that has a semicircular shape and protrudes from the bottom surface of the concave part 48 in the Z-direction, at a position facing the groove 37a. A protruding height of the protruding part 37b is one third or less of the wall surface of the concave part 48. Between the protruding part 37b and the wall surface of the concave part 48 (the groove 37a), there is shaped a bore into which an end of the second supporting shaft 38 is press-fit.

Moreover, as shown in FIG. 4 and FIG. 5, the first-case-side facing part 45 is provided with a first-case-side raised bottom part 51 (a bottom-up part) that is raised from the first-case-side base surface 47 in the second direction Z2 of the Z-direction, at a position being free from overlap with each of the electrically-conductive members 11, 12, and 13 as well as the contact-point move mechanism 21, in a view from the Z-direction. In the present example, the first-case-side raised bottom part 51 is located at an end part of the first-case-side facing part 45 in the second direction X2 of the X-direction.

Furthermore, the first-case-side facing part 45 is provided with a first-case-side platform part 52 (a bottom-up part) that is raised from the first-case-side base surface 47 in the second direction Z2 of the Z-direction, at a position being free from overlap with the first gear 29, the second gear 30, the third gear 31, the fourth gear 32, and the rotary cam 26 of the contact-point move mechanism 21, as well as the contact-point shaping part 18 of each of the electrically-conductive members 11, 12, and 13, in a view from the Z-direction; wherein the first-case-side platform part 52 is an area being continuous with the first-case-side raised bottom part 51. In the present example; as the first-case-side platform part 52, an area located at a position further away in relation to the first electrically-conductive member 11 in the first direction Y1 of the Y-direction is extended from the first-case-side raised bottom part 51 in the first direction X1 of the X-direction so as to reach the electrically-conductive member fixing part 17. In the meantime, an end of the first-case-side platform part 52 in the first direction Y1 of the Y-direction is continuous with the first-case-side outer circumferential wall part 46. Incidentally, an end surface of the first-case-side platform part 52 in the second direction Z2 of the Z-direction is located at a side in the first direction Z1 of the Z-direction (a side of the first-case-side base surface 47) in relation to an end surface of the first-case-side raised bottom part 51 in the second direction Z2 of the Z-direction. A height of the end surface of the first-case-side platform part 52 in the second direction Z2 of the Z-direction is a height that does not interfere with the elastic deforming part 19 of each of the electrically-conductive members 11, 12, and 13 as well as the tooth part 33a of the ratchet gear 33, which are located at a position that overlaps with the first-case-side platform part 52, in a view in the Z-direction.

As shown in FIG. 6, at an end surface 2a of the first case 2, which faces the first direction Z1 of the Z-direction, the first case 2 is provided with a contact part 2b, being C-shaped, with which an end surface of an output side of a motor main body 22a of the motor 22 contact. Moreover, the first case 2 is provided with a concave part 53 and a storage concave part 54 to store the transmission gear mechanism 23, at an inner circumferential side of the contact part 2b. Being stacked on the end surface 2a of the second case 3, the cover 4 covers the motor 22 and the transmission gear mechanism 23 from the first direction Z1 of the Z-direction.

At an edge part located at a side further away in relation to the contact part 2b of the end surface 2a of the first case 2 in the second direction X2 of the X-direction, there is provided a cutout part 55 that is cut out from a side of the second direction X2 of the X-direction and a side of the first direction Z1 of the Z-direction. The cutout part 55 is located at a position that overlaps the first-case-side raised bottom part 51 in a view from the Z-direction. In this situation, a provision of the cutout part 55 to the end surface 2a of the first case 2 protects a thickness dimension of the first-case-side raised bottom part 51 in the Z-direction from becoming remarkably thick in comparison to any other part of the first-case-side facing part 45. Meanwhile, in the end surface 2a of the first case 2, there are provided a plurality of concave parts 56 at positions that overlap either the first-case-side platform part 52 or the electrically-conductive member fixing part 17 in a view from the Z-direction. A provision of these concave parts 56 protects a thickness dimension of the first-case-side platform part 52 and the electrically-conductive member fixing part 17 in the Z-direction from becoming remarkably thick in comparison to any other part of the first-case-side facing part 45.

(The Second Case)

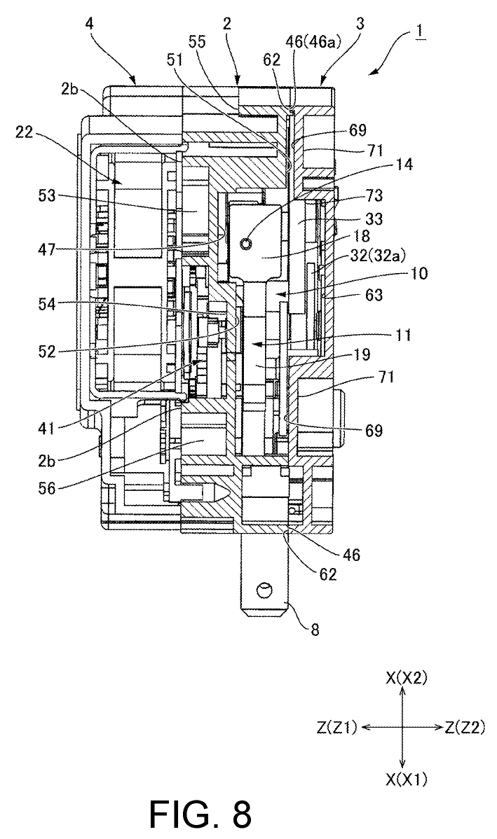

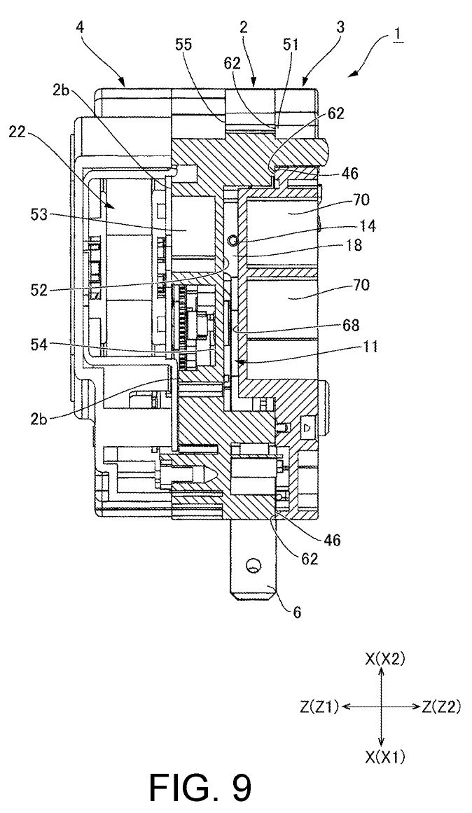

The second case 3 is explained next in details with reference to FIG. 1 and FIG. 7 through FIG. 9. FIG. 7(a) is a plan view of the second case 3 in which each of the electrically-conductive members 11, 12, and 13 and the contact-point move mechanism 21 are stored, wherein the second case 3 is viewed from a location in the first direction Z1 of the Z-direction; and FIG. 7(b) is a perspective view drawing of the second case 3, viewed from a location in the first direction Z1 of the Z-direction and the first direction Y1 of the Y-direction. FIG. 8 is a sectional view drawing of the defrosting timer for a refrigerator 1, shown in FIG. 1, wherein being taken along a line A-A mentioned in FIG. 1. FIG. 9 is a sectional view drawing of the defrosting timer for a refrigerator 1, shown in FIG. 1, wherein being taken along a line B-B mentioned in FIG. 1.

As shown in FIG. 7(b), the second case 3 is provided with a second-case-side facing part 61 (a second facing part) that faces the first case 2, and a second-case-side outer circumferential wall part 62 that protrudes from a circumferential edge of the second-case-side facing part 61 in the first direction Z1 of the Z-direction. The second-case-side facing part 61 has a shape corresponding to the first-case-side facing part 45 of the first case 2. Accordingly, being viewed from the Z-direction, the second-case-side facing part 61 has a plan view that is a rectangular form, as a whole. Then, the second-case-side outer circumferential wall part 62 is a frame being shaped to be rectangular, as a whole. An edge part of the second-case-side outer circumferential wall part 62 in the first direction Z1 of the Z-direction is a counter-mating part that fits into the mating part 46a of the first-case-side outer circumferential wall part 46 of the first case 2 at a time when the first case 2 and the second case 3 are stacked.

The second-case-side facing part 61 includes a second-case-side base surface 63 that faces the first case 2, while sandwiching the contact-point move mechanism 21 (including the first gear 29, the second gear 30, the third gear 31, the fourth gear 32, and the ratchet gear 33), the rotary cam 26, and each of the contact points 14, 15, and 16 between the second-case-side base surface 63 and the first case 2. In the second-case-side base surface 63, there is provided a bearing part 64, being tubular, with which the ratchet gear 33 is supported so as to be rotatable. Meanwhile, at a side further away in relation to the bearing part 64 in the second-case-side base surface 63 in the first direction X1 of the X-direction, there are provided a first supporting shaft holding part 66, being tubular, which holds an end part of the first supporting shaft 36, and a second supporting shaft holding part 67, being tubular, which holds an end part of the second supporting shaft 38.

Meanwhile, as shown in FIG. 7(a), the second-case-side facing part 61 is provided with a second-case-side raised bottom part 68 (a bottom-up part) that is raised from the second-case-side base surface 63 in the first direction Z1 of the Z-direction, at a position being free from overlap with each of the electrically-conductive members 11, 12, and 13 as well as the contact-point move mechanism 21, in a view from the Z-direction. The second-case-side raised bottom part 68 protrudes in the first direction Z1 of the Z-direction in comparison to the second-case-side outer circumferential wall part 62, as shown in FIG. 7(b). In the present example, the second-case-side raised bottom part 68 is located at an end part of the second-case-side facing part 61 in the first direction Y1 of the Y-direction. A position, at which the second-case-side raised bottom part 68 is provided, is a position being free from overlap with the first-case-side raised bottom part 51 in a situation where the first case 2 and the second case 3, being stacked, are viewed in the Z-direction.

Furthermore, the second-case-side facing part 61 is provided with a second-case-side platform part 69 (a bottom-up part) that is raised from the second-case-side base surface 63 in the first direction Z1 of the Z-direction, at a position being free from overlap with the contact-point move mechanism 21, as well as the contact-point shaping part 18 of each of the electrically-conductive members 11, 12, and 13, in a view from the Z-direction; wherein the second-case-side platform part 69 is an area being continuous with the second-case-side raised bottom part 68. An end surface of the second-case-side platform part 69 in the first direction Z1 of the Z-direction is located at a side in the second direction Z2 of the Z-direction (a side of the second-case-side base surface 63) in relation to an end surface of the second-case-side raised bottom part 68 in the first direction Z1 of the Z-direction. Meanwhile, a height of the end surface of the second-case-side platform part 69 in the second direction Z2 of the Z-direction is a height that does not interfere with the elastic deforming part 19 of each of the electrically-conductive members 11, 12, and 13, which are located at a position that overlaps with the second-case-side platform part 69, in a view in the Z-direction. In the present example, the second-case-side platform part 69 is extended from the second-case-side raised bottom part 68 in the second direction X2 of the X-direction so as to become continuous with the second-case-side outer circumferential wall part 62. Moreover, the second-case-side platform part 69 is extended from the second-case-side raised bottom part 68 in the first direction Y1 of the Y-direction so as to become continuous with the second-case-side outer circumferential wall part 62. Furthermore, the second-case-side platform part 69 is extended toward a side in the first direction X1 of the X-direction.

Then, as shown in FIG. 1, the second case 3 is provided with a first concave part 70 recessed in the first direction Z1 of the Z-direction, in an end surface 3a facing the second direction Z2 of the Z-direction, at a position that overlaps with the second-case-side raised bottom part 68, in a view from the Z-direction. A provision of the first concave part 70 to the end surface 3a of the second case 3 protects a thickness dimension of the second-case-side raised bottom part 68 in the Z-direction from becoming remarkably thick in comparison to any other part of the second-case-side facing part 61. Moreover, the second case 3 is provided with a second concave part 71 recessed in the first direction Z1 of the Z-direction, in the end surface 3a facing the second direction Z2 of the Z-direction, at a position that overlaps with the second-case-side platform part 69, in a view from the Z-direction. The second concave part 71 is shallower than the first concave part 70. A provision of the second concave part 71 to the end surface 3a of the second case 3 protects a thickness dimension of the second-case-side platform part 69 in the Z-direction from becoming remarkably thick in comparison to any other part of the second-case-side facing part 61.

Then, in a state where the electrically-conductive members 11, 12, and 13 and the contact-point move mechanism 21 are stored in the storage space 10 partitioned between the first case 2 and the second case 3 by way of stacking the first case 2 and the second case 3; a part of the tooth part 33a of the ratchet gear 33 at a side in the second direction Z2 of the Z-direction, and the fourth large gear part 32a of the fourth gear 32 are inserted in a concave part 73 of the second case 3, which is made up with an area where the second-case-side platform part 69 and the second-case-side raised bottom part 68 are not formed, while the second-case-side base surface 63 being used as a bottom surface, as shown in FIG. 8. Meanwhile, the first-case-side raised bottom part 51 of the first case 2 faces the second-case-side platform part 69 of the second case 3, while having a small clearance there. Moreover, the second-case-side raised bottom part 68 of the second case 3 intrudes inside the first-case-side outer circumferential wall part 46 of the first case 2, and faces the first-case-side platform part 52, while having a small clearance there, as shown in FIG. 9.

(Operation of the Defrosting Timer for a Refrigerator)

Operation of the defrosting timer for a refrigerator 1 is explained next with reference to FIG. 10. FIG. 10 includes plan view drawings of surroundings of the rotary cam 26 and each of the contact points 14, 15, and 16, which are viewed from the first direction Z1 of the Z-direction. FIG. 10(a) shows a situation in which the second contact point 15 and the third contact point 16 contact with each other; FIG. 10(b) shows a situation in which the first contact point 14 and the second contact point 15 contact with each other; and FIG. 10(c) shows a situation in which the second contact point 15 and the third contact point 16 contact again with each other after the situation shown in FIG. 10(b).

As the cam surface 25, the rotary cam 26 includes an inner circumferential cam surface 81, and an outer circumferential cam surface 82 that is located at an outer circumferential side than the inner circumferential cam surface 81 is, as shown in FIG. 10. The inner circumferential cam surface 81 is located at a position in the first direction Z1 of the Z-direction, in relation to the outer circumferential cam surface 82. The inner circumferential cam surface 81 is a cam surface on which the contact-point shaping part 18 of the second electrically-conductive member 12, and the third electrically-conductive member 13 slides with contacting; and meanwhile, the outer circumferential cam surface 82 is a cam surface on which the contact-point shaping part 18 of the first electrically-conductive member 11 slides with contacting.

The inner circumferential cam surface 81 is provided with an inner circumferential spiral cam surface part 81a extending in a spiral form, and an inner circumferential step part 81b, which connects a part located at an inner circumferential side and a part located at an outer circumferential side, in the spiral cam surface part 81a, at a certain angular position in a circumferential direction. Meanwhile, the outer circumferential cam surface 82 is provided with an outer circumferential spiral cam surface part 82a extending in a spiral form, and an outer circumferential step part 82b, which connects a part located at an inner circumferential side and a part located at an outer circumferential side, of the outer circumferential spiral cam surface part 82a, at a certain angular position in a circumferential direction. The inner circumferential step part 81b is located a little behind, in a rotating direction R1 of the rotary cam 26, after the outer circumferential step part 82b. Incidentally, with respect to the three electrically-conductive members, i.e., the electrically-conductive members 11, 12, and 13; a tip of the second electrically-conductive member 12, provided with the second contact point 15, protrudes in the second direction X2 of the X-direction, in comparison to a tip point of the other two electrically-conductive members, i.e., the electrically-conductive members 11 and 13; and a tip of the first electrically-conductive member 11, provided with the first contact point 14, and a tip of the third electrically-conductive member 13, provided with the third contact point 16 are placed at a position in the first direction X1 of the X-direction, in comparison to the tip of the second electrically-conductive member 12.

In the situation shown in FIG. 10(a), the first electrically-conductive member 11 slides at a position on the outer circumferential spiral cam surface part 82a, wherein the position is advanced in comparison to the outer circumferential step part 82b in the rotating direction R1. Meanwhile, the third electrically-conductive member 13 slides at a position on the inner circumferential spiral cam surface part 81a, wherein the position is advanced in comparison to the inner circumferential step part 81b in the rotating direction R1. In the meantime, the second electrically-conductive member 12, which is connected to the segment 6 as the shared segment, slides on neither the inner circumferential cam surface 81 nor the outer circumferential cam surface 82.

In this situation, the second electrically-conductive member 12 is biased toward a side of the rotary cam 26 because of its own shape-restoring force so that the contact point 15 of the second electrically-conductive member 12 contacts the contact point 16 of the third electrically-conductive member 13 that is located at a side of the rotary cam 26 in relation to the second electrically-conductive member 12. Meanwhile, the contact point 15 of the second electrically-conductive member 12 is distant from the first contact point 14 of the first electrically-conductive member 11 sliding at the outer circumferential step part 82b. Accordingly, the compressor, being connected to the third electrically-conductive member 13 by the intermediary of the third segment 7, turns on; and meanwhile, the heater being connected to the first electrically-conductive member 11 by the intermediary of the first segment 5, turns off.

Then, as the rotary cam 26 rotates in the rotating direction R1, the third electrically-conductive member 13 passes over the inner circumferential step part 81b so that the third electrically-conductive member 13 moves to an inner circumferential side of the rotary cam 26 so as to get into a situation for sliding with contacting on the inner circumferential spiral cam surface part 81a. Then, the second electrically-conductive member 12 gets into a situation for sliding with contacting at a position on the inner circumferential spiral cam surface part 81a, wherein the position is advanced in comparison to the inner circumferential step part 81b in the rotating direction R1. Accordingly, the contact point 15 of the second electrically-conductive member 12 and the contact point 16 of the third electrically-conductive member 13 become distant from each other so that the compressor turns off.

Then, the first electrically-conductive member 11 passes over the outer circumferential step part 82b. In this situation, the first electrically-conductive member 11 is biased toward a side of the rotary cam 26 because of its own shape-restoring force so that the first electrically-conductive member 11, having passed over the outer circumferential step part 82b, moves toward an inner circumferential side of the rotary cam 26. As a result of that, the contact point 14 of the first electrically-conductive member 11 contacts the contact point 15 of the second electrically-conductive member 12, which is placed at a side of the rotary cam 26 in relation to the first electrically-conductive member 11. Accordingly, the heater, being connected to the first electrically-conductive member 11 by the intermediary of the first segment 5, turns on. Incidentally, while the compressor is off and the heater is on, frost inside the refrigerator chamber is removed.

Then, at a time when the rotary cam 26 further rotates in the rotating direction R1 so that the second electrically-conductive member 12 passes over the inner circumferential step part 81b, the second electrically-conductive member 12 moves toward an inner circumferential side of the rotary cam 26, as shown in FIG. 10(c). Moreover, if the second electrically-conductive member 12 moves toward the inner circumferential side of the rotary cam 26, the first electrically-conductive member 11 having contacted the second electrically-conductive member 12 gets into a situation for sliding with contacting on the outer circumferential spiral cam surface part 82a. In this situation, the contact point 15 of the second electrically-conductive member 12 becomes distant from the contact point 14 of the first electrically-conductive member 11. Accordingly, the heater, being connected to the first electrically-conductive member 11 by the intermediary of the first segment 5, turns off. In the meantime, as the second electrically-conductive member 12 moves toward the inner circumferential side of the rotary cam 26, the contact point 15 of the second electrically-conductive member 12, the contact point 15 of the second electrically-conductive member 12 contacts the contact point 16 of the third electrically-conductive member 13, which slides with contacting on the inner circumferential spiral cam surface part 81a. Accordingly, the compressor, being connected to the third electrically-conductive member 13 by the intermediary of the third segment 7, turns on. Then, as the rotary cam 26 further rotates, the situation shown in FIG. 10(a) is restored. Thus, the situations shown in FIG. 10(a) through FIG. 10(c) get repeated.

(Operation and Effect)

In the present example, the first case 2 is provided with the first-case-side raised bottom part 51, in the first-case-side facing part 45 that faces the second case 3; and meanwhile, the second case 3 is provided with the second-case-side raised bottom part 68, in the second-case-side facing part 61 that faces the first case 2. Therefore, the storage space 10, which stores the plurality of electrically-conductive members 11, 12, and 13 as well as the contact-point move mechanism 21, has its capacity that is smaller than a corresponding capacity in the case where the first-case-side raised bottom part 51 and the second-case-side raised bottom part 68 are not provided, in comparison. Then, if the capacity of the storage space 10 becomes small, a risk of setting off an explosion is reduced even in the case where a spark is caused owing to the contact points 14, 15, and 16 contacting one another.

Moreover, in the present example, the motor 22 that works as a drive source for the contact-point move mechanism 21, and the transmission gear mechanism 23 for transmitting a drive power from the motor 22 to the contact-point move mechanism 21 are stored between the first case 2 and the cover 4; and therefore, it is easy to make the capacity of the storage space 10 small, in comparison to a case where the motor 22 and the transmission gear mechanism 23 are stored in the storage space 10.

Furthermore, in the present example, each of the gears 29, 30, 31, and 32, and the ratchet gear 33 as well as the rotary cam 26, all of which make up the contact-point move mechanism 21, have their rotation centerlines oriented along the Z-direction (the stacking direction of the first case 2 and the second case 3). Therefore, it is easy to make the storage space 10, for the plurality of electrically-conductive members 11, 12, and 13 and the contact-point move mechanism 21, compact in the stacking direction, in comparison to a case where these rotation centerlines are perpendicular to the stacking direction. Accordingly, the capacity of the storage space 10 can easily be made small.

Still further, in the present example, in the first-case-side base surface 47 of the first-case-side facing part 45, there is provided the concave part 48 recessed in a direction to become distant from the second case 3, and the first large gear part 29a of the first gear 29 is stored in the concave part. Moreover, in the first case 2, there is provided the first-case-side platform part 52 that is raised from the first-case-side base surface 47 down to a position lower than the first-case-side raised bottom part 51. In the same manner, in the second case 3, there is provided the second-case-side platform part 69 that is raised from the second-case-side base surface 63 down to a position lower than the second-case-side raised bottom part 68. Therefore, the storage space 10, which stores the plurality of electrically-conductive members 11, 12, and 13 as well as the contact-point move mechanism 21, has its capacity that is smaller than a corresponding capacity in the case where the concave part 48 and these platform parts 52 and 69 are not provided, in comparison. Moreover, the concave part 48 is provided with the opening part 43 so that it is easy to engage the first gear 29 inside the storage space 10 with the transmission gear 41 located between the first case 2 and the second case 3.

Moreover, in the present example, at a time when the first case 2 and the second case 3 are stacked, the first-case-side raised bottom part 51 of the first case 2 faces the second-case-side platform part 69 of the second case 3, while having a small clearance there. Meanwhile, the second-case-side raised bottom part 68 of the second case 3 faces the first-case-side platform part 52, while having a small clearance there. In other words, when the first case 2 and the second case 3 are stacked, the first-case-side raised bottom part 51 of the first case 2 has no chance to interfere with the second case 3, and the second-case-side raised bottom part 68 of the second case 3 has no chance to interfere with the first-case-side facing part 45 of the first case 2. Therefore, the first case 2 and the second case 3 can be stacked for sure so as to partition the storage space 10 between the first case 2 and the second case 3.

Meanwhile, in the present example, in the end surface 2a of the first case 2 in the first direction Z1 of the Z-direction, there is provided the cutout part 55 at the position that overlaps the first-case-side raised bottom part 51. Moreover, in the end surface 3a of the second case 3 in the second direction Z2 of the Z-direction, there is provided the concave part 70 at the position that overlaps with the second-case-side raised bottom part 68. According to this configuration, it is possible to protect a thickness of the case 2 and the case 3 from becoming thick, at the raised bottom part 51 and the raised bottom part 68, respectively. Therefore, deformation of the case 2 and the case 3 owing to a shrinkage can be suppressed at a time of mold injection of the case 2 and the case 3.

DESCRIPTION OF REFERENCE NUMERALS

| | |
|---|---|
| 1: | defrosting timer for a refrigerator (contact-point timer switch) |
| 2: | first case |
| 2a: | end surface |
| 2b: | contact part |
| 3: | second case |
| 3a: | end surface |
| 4: | cover |
| 5: | first segment |
| 6: | second segment |
| 7: | third segment |
| 8: | fourth segment |
| 10: | storage space |
| 11: | first electrically-conductive member |
| 12: | second electrically-conductive member |
| 13: | third electrically-conductive member |
| 14: | first contact point |
| 15: | second contact point |
| 16: | third contact point |
| 17: | electrically-conductive member fixing part |
| 18: | contact-point shaping part |
| 19: | elastic deforming part |
| 21: | contact-point move mechanism |
| 22: | motor |
| 22a: | motor main body |
| 23: | transmission gear mechanism |
| 25: | cam surface |
| 26: | rotary cam |
| 26a: | annular concave part |
| 26b: | engagement claw |
| 27: | gear mechanism |
| 29: | first gear |
| 29a: | first large gear part |
| 30: | second gear |
| 30a: | second large gear part |
| 31: | third gear |
| 31a: | third large gear part |
| 31b: | third small gear part |
| 32: | fourth gear |
| 32a: | fourth large gear part |
| 33: | ratchet gear |
| 33a: | tooth part |
| 33b: | ratchet claws |
| 35: | first supporting shaft holding part |
| 36: | first supporting shaft |
| 37: | second supporting shaft holding part |
| 37a: | groove |
| 37b: | protruding part |
| 38: | second supporting shaft |
| 41: | transmission gear |
| 41a: | large gear part |
| 41b: | small gear part |
| 43: | opening part |
| 44: | condenser |
| 45: | first-case-side facing part |
| 46: | case-side outer circumferential wall part |
| 46a: | mating part |
| 47: | first-case-side base surface |
| 48: | concave part |
| 51: | first-case-side raised bottom part (bottom-up part) |
| 52: | first-case-side platform part (bottom-up part) |
| 53: | concave part |
| 54: | storage concave part |
| 55: | cutout part |
| 56: | concave parts |
| 61: | second-case-side facing part |
| 62: | second-case-side outer circumferential wall part |
| 63: | second-case-side base surface |
| 64: | bearing part |
| 66: | first supporting shaft holding part |
| 67: | second supporting shaft holding part |
| 68: | second-case-side raised bottom part (bottom-up part) |
| 69: | second-case-side platform part (bottom-up part) |
| 70: | concave part |
| 71: | concave part |
| 73: | concave part |
| 81: | inner circumferential cam surface |
| 81a: | inner circumferential spiral cam surface part |
| 81b: | inner circumferential step part |
| 82: | outer circumferential cam surface |
| 82a: | outer circumferential spiral cam surface part |
| 82b: | outer circumferential step part |

1. A contact-point timer switch, comprising:
a plurality of contact points;
a contact-point move mechanism that moves at least one contact point of the plurality of contact points, and makes the contact point contact another contact point in order to electrically connect the contact points; and
a case, inside which the plurality of contact points and the contact-point move mechanism are stored;
wherein,
the case includes a first case and a second case, for partitioning a storage space for internally storing the plurality of contact points and the contact-point move mechanism, while the first case and the second case being in a stacked state;
at least one of a first facing part and a second facing part includes a raised bottom part that is raised from a bottom toward the other facing part, the first facing part facing the second case inside the storage space in the first case, the second facing part facing the first case inside the storage space in the second case; and
the raised bottom part does not interfere with the contact points and the contact-point move mechanism.

2. The contact-point timer switch according to claim 1, wherein
the raised bottom part is provided in an area being free from overlap with the contact points and the contact-point move mechanism, in a view from a stacking direction of the first case and the second case.

3. The contact-point timer switch according to claim 2, further comprising:
a motor that works as a drive source for the contact-point move mechanism;
a transmission gear mechanism for transmitting a drive power from the motor to the contact-point move mechanism; and
a cover, stacked on the first case from an opposite side to the second case in the stacking direction;
wherein, the motor and the transmission gear mechanism are located between the first case and the cover.

4. The contact-point timer switch according to claim 3, further comprising:
a plurality of electrically-conductive members, and a number of the electrically-conductive members corresponding to a number of the contact points;
each of the contact points is a part of each of the electrically-conductive members;
the contact-point move mechanism comprises:
a rotary cam, having a cam surface on which each of the electrically-conductive members slides; and
a gear mechanism for transmitting a drive power of the motor to the rotary cam;
wherein, each of gears for making up the gear mechanism and the rotary cam have their rotation centerlines oriented in the stacking direction.

5. The contact-point timer switch according to claim 4, wherein
the gear mechanism comprises: a first gear to which the drive power is transmitted from the transmission gear mechanism, and a second gear that engages with the first gear;
the first facing part comprises:
a first-case-side base surface, facing the second facing part, while sandwiching the second gear and the rotary cam between the first-case-side base surface and the second facing part;
a concave part that is provided in the first-case-side base surface and recessed to become distant from the second case in the stacking direction;
an opening part, provided in the concave part; and
a first-case-side raised bottom part, as the raised bottom part, which is raised from the first-case-side base surface toward the second facing part;
wherein, a part of the first gear is stored in the concave part; and
the first gear engages with the transmission gear mechanism by way of the opening part.

6. The contact-point timer switch according to claim 5, wherein
the first facing part is provided with a supporting shaft holding part that holds a supporting shaft to support the second gear in such a way as to be rotatable, at a boundary between the first-case-side base surface and the concave part.

7. The contact-point timer switch according to claim 5, wherein
the second facing part comprises:
a second-case-side base surface, facing the first facing part, while sandwiching the contact-point move mechanism between the second-case-side base surface and the first facing part; and
a second-case-side raised bottom part, as the raised bottom part, which is raised from the second-case-side base surface toward the first facing part, at a position being free from overlap with the first-case-side raised bottom part provided at the first facing part, in a view from the stacking direction.

8. The contact-point timer switch according to claim 7, wherein
the first case has a frame shape, and including a first-case-side outer circumferential part that protrudes from a circumferential edge of the first facing part in the stacking direction; and
an edge of the first-case-side raised bottom part is continuous with the first-case-side outer circumferential part.

9. The contact-point timer switch according to claim 8, wherein
the second case has a frame shape, and including a second-case-side outer circumferential part that protrudes from a circumferential edge of the second facing part in the stacking direction; and
the second-case-side raised bottom part protrudes in the stacking direction in comparison to the second-case-side outer circumferential part.

10. The contact-point timer switch according to claim 1, wherein
a clearance is set up between the raised bottom part provided at one facing part of the first facing part and the second facing part, and the other facing part that faces the raised bottom part in the stacking direction.

11. The contact-point timer switch according to claim 1, wherein
the first case and the second case are made of a resin material, and
one case of the first case and the second case, including the raised bottom part, is provided with a concave part recessed in the stacking direction, at an opposite side to the other case, the opposite side being of the facing part of the one case, at a position that overlaps with the raised bottom part in a view from the stacking direction.

12. The contact-point timer switch according to claim 6, wherein
the second facing part comprises:
a second-case-side base surface, facing the first facing part, while sandwiching the contact-point move mechanism between the second-case-side base surface and the first facing part; and
a second-case-side raised bottom part, as the raised bottom part, which is raised from the second-case-side base surface toward the first facing part, at a position being free from overlap with the first-case-side raised bottom part provided at the first facing part, in a view from the stacking direction.
